(19) United States
(12) Patent Application Publication
(10) Pub. No.: US 2011/0085967 A1
(43) Pub. Date: Apr. 14, 2011

(54) HYDROGEN PRODUCT METHOD AND APPARATUS

(76) Inventors: Troy Michael Raybold, Colden, NY (US); Gregory Joseph Panuccio, E. Amherst, NY (US); Jerome Thomas Jankowiak, Williamsville, NY (US); Vasilis Papavassiliou, Williamsville, NY (US); Raymond Francis Drnevich, Clarence Center, NY (US)

(21) Appl. No.: 12/578,661

(22) Filed: Oct. 14, 2009

(51) Int. Cl. C01B 3/26; B01J 10/00

(52) U.S. Cl. 423/652; 422/626; 422/627

(57) ABSTRACT

A method and apparatus for producing a hydrogen containing product in which hydrocarbon containing feed gas streams are reacted in a steam methane reformer of an existing hydrogen plant and a catalytic reactor that reacts hydrocarbons, oxygen and steam. The catalytic reactor is a retrofit to the existing hydrogen plant to increase hydrogen production. The resulting synthesis gas streams are combined, cooled, subjected to water-gas shift and then introduced into a production apparatus that can be a pressure swing adsorption unit. The amount of synthesis gas contained in a shifted stream made available to the production apparatus is increased by virtue of the combination of the synthesis gas streams to increase production of the hydrogen containing product. The catalytic reactor is operated such that the synthesis gas stream produced by such reactor is similar to that produced by the steam methane reformer and at a temperature that will reduce oxygen consumption within the catalytic reactor.

### FIELD OF THE INVENTION

The present invention relates to a method and apparatus for producing a hydrogen containing product, that can be hydrogen, in which hydrocarbon containing feeds are reacted with steam in a steam methane reformer employed in a hydrogen plant and with oxygen and steam in a catalytic reactor that is a retrofit to the hydrogen plant.

### BACKGROUND OF THE INVENTION

Hydrogen and other hydrogen containing products are commonly produced in a hydrogen plant that employs a steam methane reformer. The typical feed to such a plant is natural gas, although other hydrocarbon containing feed can be used such as naphtha and off-gas streams produced in a refineries or steel plants. Any of such feeds contain sulfur species that potentially could damage the catalyst employed in the reformer and as a result, such feeds are treated by such means as bulk sulfur removal units located upstream of the reformer and then in hydrotreaters to hydrogenate the sulfur species to hydrogen sulfide and in adsorbent beds commonly using consumable zinc oxide adsorbent to adsorb the hydrogen sulfide.

Superheated steam is then combined with the treated feed and the resulting reactant stream is feed into reformer tubes containing a reforming catalyst to react the steam with the hydrocarbons contained in the feed to produce hydrogen, carbon dioxide, carbon monoxide and additional steam in known steam methane reforming reactions. The steam methane reforming reaction is endothermic and thus, the reformer tubes are heated by burners firing into a furnace section of the reformer that houses the reformer tubes. The resulting flue gas produced by the burners is then passed through a convective section of the steam methane reformer that contains heat exchangers to heat boiler feed water into the superheated steam that is used in the reforming operation and also, for export.

The hydrogen and carbon monoxide containing stream that exits from the reformer tubes and, after being cooled in a product gas boiler associated with the steam generation system, is subjected to one or more stages of water-gas shift in reactors containing a suitable catalyst for such purposes. The water-gas shift reactors react steam with the carbon monoxide to produce a shifted stream containing more hydrogen than the entering hydrogen and carbon monoxide containing stream. After further cooling in process heaters, the shifted stream is introduced into a pressure swing adsorption unit to separate the hydrogen from the shifted stream and thereby to produce a hydrogen product stream and a tail gas stream. The tail gas stream is used as part of the fuel to the burners firing into the furnace section of the reformer. Alternatively, the shifted stream can be introduced into another set of unit processes utilizing the shifted stream. For example, carbon dioxide could be separated from the shifted stream and then, the shifted stream could be introduced into a methanation unit in which the hydrogen is reacted with the carbon monoxide to produce a synthetic or substitute natural gas.

Autothermal reformers have been used in connection with steam methane reformers to increase production of a synthesis gas containing hydrocarbon and carbon monoxide and possibly nitrogen for the production of ammonia and methanol. For example, in U.S. Pat. No. 6,207,078, hydrocarbons and steam are reacted in a primary reformer that is connected to a secondary reforming section to react remaining hydrocarbons and steam with oxygen and thereby produce a hydrogen and carbon monoxide containing stream. At the same time, hydrocarbons are also reacted in an autothermal reformer with steam and oxygen supplied by air to produce another hydrogen and carbon monoxide containing stream, also containing nitrogen. The two hydrogen and carbon monoxide containing streams are mixed and then fed to a high temperature shift conversion unit and a carbon dioxide separation unit. Separated carbon dioxide is then fed to a urea production unit and another part is purified and used to synthesize ammonia that is then fed into the urea production unit to react with carbon dioxide and produce urea.

As indicated in this patent, the autothermal reformer and in which hydrocarbons are reacted with oxygen and steam and possibly an upstream prereformer can be a retrofit to an existing plant to increase production of the synthesis gas for downstream processing. The problem with this is that for the production of hydrogen, the use of such an autothermal reformer is not a particularly cost effective way of increasing the production of hydrogen given that the expense of the oxygen comes into play resulting in unacceptably high production costs. In the embodiments shown in U.S. Pat. No. 6,207,078 it is desired that oxygen enriched air be the feed to the autothermal reformer thus saving on the cost of oxygen. This is no impediment in this patent in that it is desired that the resulting synthesis gas stream contain nitrogen since ammonia and urea are to be produced. However, where hydrogen is to be produced, it is not desirable to thus add more nitrogen to the synthesis gas given that the same will have to be separated from the synthesis gas in a pressure swing adsorption unit. Consequently, the use of a higher purity oxygen containing stream even in this patent is not a particularly cost effective integration given that in autothermal reformering, typically, the reformer is operated so as to produce as complete a methane conversion as possible and the oxygen consumption required for such conversion represents an unacceptable high cost. This high cost of oxygen makes the addition of an autothermal reformer to a hydrogen plant impractical.

As will be discussed, among other advantages, the present invention discloses a method and apparatus for production of hydrogen that employs a catalytic reactor operating in an autothermal mode that is added as a practical, cost effective, retrofit to an existing hydrogen plant.

### SUMMARY OF THE INVENTION

In one aspect, the present invention provides a method of producing a hydrogen containing product. In accordance with such method, a first hydrocarbon containing feed gas stream is reacted with steam in a steam methane reformer of an existing hydrogen plant to produce a first synthesis gas stream. Production of the hydrogen is increased within the existing hydrogen plant by retrofitting the existing hydrogen plant with a catalytic reactor that reacts a second hydrocarbon containing feed gas stream with steam and oxygen. The reactions within the catalytic reactor produce a second synthesis gas stream that has a methane slip of at least about 2.0 dry mol percent, a hydrogen to carbon monoxide ratio of at least about 4.0 on a molar basis and a temperature of no greater than about 870° C.

The second synthesis gas stream is combined with the first synthesis gas stream to produce a combined stream. Either the combined stream is cooled or the first synthesis gas stream and the second synthesis gas stream are separately cooled such that the combined stream is at a temperature suitable for introduction into a water-gas shift reactor of the existing hydrogen plant.

The combined stream is subjected to at least one stage of a water-gas shift reaction conducted within the water-gas shift reactor to form a shifted stream having more of the hydrogen than the combined stream. The synthesis gas in the shifted stream is utilized in a downstream unit operation to produce the hydrogen containing product. As a result of the retrofit, an amount of the synthesis gas provided to the shifted stream available for the downstream unit operation is increased by virtue of combination of the second synthesis gas stream with the first synthesis gas stream.

The downstream unit operation can be a hydrogen pressure swing adsorption unit. In such case, the shifted stream is cooled and the hydrogen is separated from the shifted stream within the hydrogen pressure swing adsorption unit to produce a hydrogen stream containing the hydrogen as the hydrogen containing product and a tail gas stream. The tail gas stream is utilized as part of a fuel fed to burners firing into a furnace section of the steam methane reformer at a tail gas flow rate of the tail gas stream that is greater than before the retrofit of the catalytic reactor to decrease consumption of a remaining part of the fuel.

As can be appreciated, by limiting the temperature of the catalytic reactor to 870° C., the amount of oxygen will be reduced over that required had the reactor been operated at a higher temperature so that all of the hydrocarbons contained in the feed were reacted with no methane slip. Additionally, since more hydrocarbons are being reacted in both the steam methane reformer and the catalytic reactor more synthesis gas will be produced for use in the downstream operation to increase production of the hydrogen containing product. This is particularly advantageous when the downstream operation is a hydrogen pressure swing adsorption unit because not only will more hydrogen be produced, to in turn increase hydrogen production, but also, more tail gas will be produced as a result of the hydrogen being separated from the shifted stream. Typically, the fuel supplied to burners firing into the furnace section is a combination of natural gas and tail gas. The increased production of the tail gas will decrease the requirements for the natural gas and therefore, make the retrofit even more attractive from a financial standpoint

A feed gas stream containing hydrocarbons and sulfur species can be treated by passing the feed gas stream through a hydrotreater of the existing hydrogen plant to hydrogenate the sulfur species to hydrogen sulfide and then through an adsorbent bed of the existing hydrogen plant to adsorb the hydrogen sulfide, thereby to form a treated feed gas stream. The treated feed gas stream is divided into the first hydrocarbon containing feed gas stream and the second hydrocarbon containing feed gas stream and the flow rate of the feed gas stream after the retrofit of the catalytic reactor is increased.

The catalytic reactor can be of the type that has a burner fed with a reactant stream and the oxygen and firing into a catalyst bed. The second synthesis gas stream is combined with the further part of the steam to form the reactant stream that is heated through indirect heat transfer with the second synthesis gas stream, thereby to partly cool the second synthesis gas stream. The combined stream is cooled prior to being subjected to the at least one stage of the water-gas shift reaction within a product gas boiler of the existing hydrogen plant. Alternatively, the catalytic reactor can be provided with a catalyst configured to promote reactions between the second hydrocarbon containing gas stream, the oxygen and the steam. The first synthesis gas stream is cooled in a product gas boiler of the existing hydrogen plant and the second synthesis gas stream is separately cooled within an auxiliary boiler.

In another aspect, the present invention provides an apparatus for producing a hydrogen containing product. In accordance with such aspect of the present invention, an existing hydrogen plant is provided. The existing hydrogen plant includes a steam methane reformer, a steam generation system associated with the steam methane reformer to generate steam and at least one water-gas shift reactor in flow communication with the steam methane reformer to produce a shifted stream. The steam methane reformer is configured to react part of the steam with a first hydrocarbon containing feed gas stream to produce a first synthesis gas stream.

A catalytic reactor, provided as a retrofit to the existing hydrogen plant, is configured to react a second hydrocarbon containing feed gas stream with oxygen and a further part of the steam to produce a second synthesis gas stream. The second synthesis gas stream has a methane slip of at least about 2.0 dry mol percent, a hydrogen to carbon monoxide ratio of at least about 4.0 on a molar basis and a temperature of no greater than about 870° C. The at least one water-gas shift reactor is in flow communication with both the catalytic reactor and the steam methane reformer such that that the second synthesis gas stream combines with the first synthesis gas stream to produce a combined stream fed into the at least one water-gas shift reactor. At least one boiler is positioned between the catalytic reactor and water-gas shift reactor such that the combined stream is at a temperature suitable for entry into the at least one water-gas shift reactor. A production apparatus is provided in flow communication with the at least one water-gas shift reactor that utilizes synthesis gas in the shifted stream to produce the hydrogen containing product. As a result, an amount of the available synthesis gas provided in the shifted stream to the production apparatus is increased by virtue of combination of the second synthesis gas stream with the first synthesis gas stream such that production of the hydrogen containing product is increased.

The production apparatus can be a hydrogen pressure swing adsorption unit configured to separate the hydrogen from the shifted stream to produce a hydrogen product stream as the hydrogen containing product and a tail gas stream. The hydrogen pressure swing adsorption unit is connected to burners firing into a furnace section of the steam methane reformer such that the tail gas stream is fed as part of a fuel to burners. The existing hydrogen plant with the catalytic reactor is configured to operate such that the pressure swing adsorption unit produces the hydrogen product stream and the tail gas stream at increased production rates over the existing hydrogen plant due to the combination of the second synthesis gas stream with the first synthesis gas stream and consumption of a remaining part of the fuel fed to the burners decreases due to increased production of the tail gas stream.

The existing hydrogen plant can have a hydrotreater positioned upstream of the steam methane reformer and the catalytic reactor to treat a feed gas stream by hydrogenating sulfur species present within the feed gas stream to hydrogen sulfide and an adsorbent bed is connected to the hydrotreater to adsorb the hydrogen sulfide and thereby form a treated feed gas stream. The steam methane reformer and the catalytic reactor are in flow communication with the adsorbent bed such that the treated feed gas stream is divided into the first hydrocarbon containing feed gas stream and the second hydrocarbon containing feed gas stream.

The catalytic reactor can be of the type that has a burner fed with the second hydrocarbon containing feed gas stream and the oxygen and firing into a catalyst bed. A heat exchanger can be positioned between the catalytic reactor and the adsorption bed and in flow communication with the steam generation system such that the second hydrocarbon containing feed gas stream combines with the further part of the steam to produce a reactant stream fed to the catalytic reactor that is preheated through indirect heat transfer with the second synthesis gas stream, thereby to cool the second synthesis gas stream. The at least one boiler can be a product gas boiler of the existing hydrogen plant in flow communication with both the steam methane reformer and the catalytic reactor.

The catalytic reactor can also be of the type that has a catalyst configured to promote reactions between the second hydrocarbon containing gas stream, the oxygen and the steam. In such case, the at least one boiler is a product gas boiler of the existing hydrogen plant and an auxiliary boiler. The product gas boiler is in flow communication with the steam methane reformer such that first synthesis gas stream cools within the product gas boiler and the auxiliary boiler is in flow communication with the catalytic reactor such that the second synthesis gas stream cools within the auxiliary boiler.

In any embodiment of the present invention, or in any aspect thereof, the feed gas stream and the remaining part of the fuel fed into the burners can be natural gas.

### BRIEF DESCRIPTION OF THE DRAWINGS

While the present invention concludes with claims distinctly point out the subject matter that Applicants regard as their invention, it is believed that the invention will be better understood when taken in connection with the accompanying drawings in which:

FIG. 1 is a schematic process flow diagram of an apparatus for carrying out a method in accordance with the present invention; and

FIG. 2 is an alternative embodiment of the apparatus illustrated in FIG. 1.

### DETAILED DESCRIPTION

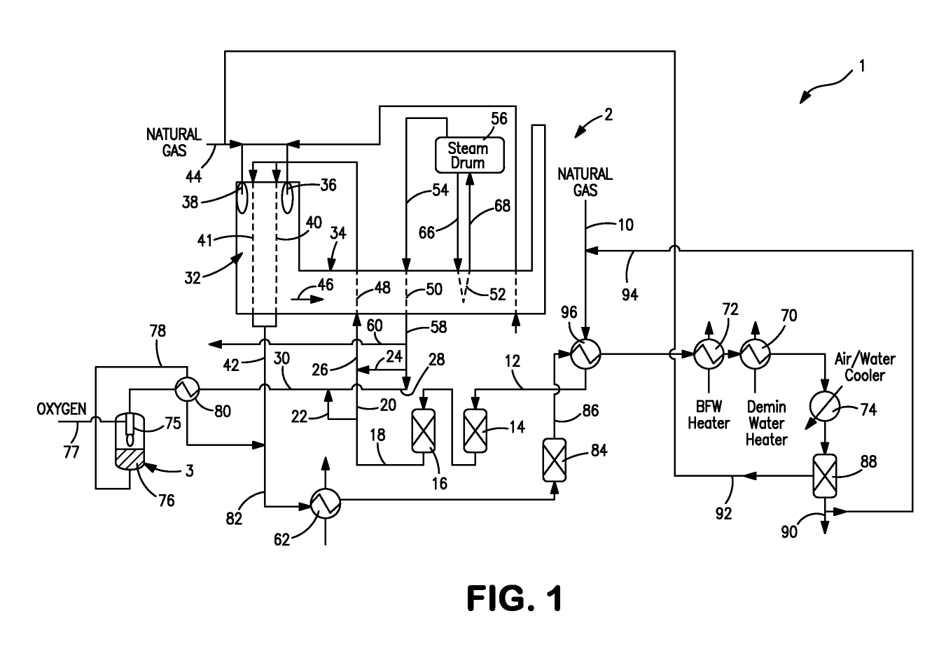

With reference to FIG. 1, a hydrogen plant 1 in accordance with the present invention is illustrated. Hydrogen plant 1 has a steam methane reformer 2 incorporating a steam generation system and a catalytic reactor 3 that has been retrofitted to the hydrogen plant 1 in order to increase its output of hydrogen. Hydrogen plant 1 is designed to reform a natural gas stream 10. However, this is simply for purposes of illustration in that hydrogen plant 1 could be designed to process any other type of hydrocarbon containing stream such as naphtha or other type of feed containing hydrocarbons. Furthermore, although the present invention is illustrated in connection with a hydrogen plant having a pressure swing adsorption unit 88 to be discussed, the present invention has broader application. For example, a shifted stream 86, also to be discussed, could be used in other types of unit operation or production apparatus such as an amine unit to remove carbon dioxide and then form a hydrogen containing fuel gas or yet other downstream operations such as a methanation unit to react the carbon monoxide and hydrogen containing in the shifted stream 86 to form a synthetic natural gas.

It is to be noted here that steam methane reformer 2 and catalytic reactor 3 produce first and second synthesis gas streams 42 and 78 that when combined into a combined stream 82 will contain more hydrogen and carbon monoxide that would have been produced by the first synthesis gas stream 42 alone, before the retrofit, an increase in the flow rate of natural gas stream 10 is needed to provide the feed to catalytic reactor 3. As a result, more synthesis gas is produced that could be used in the downstream operation or apparatus such as described above. In case of a hydrogen pressure swing adsorption unit, more hydrogen is produced that can be separated within the pressure swing adsorption unit 88 and further, more tail gas is produced as a result of the separation. It is to be noted that if the pressure swing adsorption unit 88, after the retrofit, were not able to handle the increase production of the hydrogen, a suitable modification of the pressure swing adsorption unit to handle the increased production would also have to be part of the retrofit. In any event, the greater production of tail gas allows less natural gas to be used for firing the steam methane reformer 2. This of course helps to make the retrofit even more economically feasible. At the same time, catalytic reactor 3, a typical autothermal reformer, is operated in a mode that is not typical for such a device. Typical operating modes for an autothermal reformer involve as much methane conversion as is possible. However, in the integration illustrated herein, catalytic reactor 3 is operated so that second synthesis gas stream 78 has a content that is similar to that of the first synthesis gas stream 42, with some methane slip. In order to accomplish this, a lower consumption rate of oxygen is used in catalytic reactor 3 than would otherwise have been the case had catalytic reactor been operated in a full autothermal reforming mode. This lower consumption of oxygen also helps to make the retrofit of the present invention feasible from an economic operational standpoint. A more detailed explanation of the illustrated embodiments is set forth below.

Natural gas stream 10, with a hydrogen recycle stream 94, after preheating, is introduced as a stream 12 into a hydrotreater 14. As known in the art, within hydrotreater 14, the sulfur species that are in natural gas stream 10 are converted into hydrogen sulphide. The hydrogen sulphide is then removed from such stream by a sulfur guard bed 16 that can be a zinc oxide bed. The adsorption of the hydrogen sulfide produced a treated feed gas stream 18. Treated feed gas stream 18 is then divided into a first hydrocarbon containing feed gas stream 20 and a second hydrocarbon containing feed gas stream 22. First hydrocarbon containing feed gas stream 20 is combined with a first superheated steam stream 24 to form a first reactant stream 26 that is introduced into steam methane reformer 2. Second hydrocarbon containing feed gas stream 22 is combined with a second superheated steam stream 28 to form a second reactant stream 30 that is reacted in catalytic reactor 3 with oxygen. In this regard, the term, “catalytic reactor” as used herein and in the claims means any reactor that is designed to operate in an autothermal mode of operation, namely, without the addition of heat and which the hydrocarbon contained in the feed is converted to hydrogen and carbon monoxide by catalytic partial oxidation and by steam methane reforming that is supported by the exothermic oxidation reactions. Water-gas shift reactions also occur with catalytic reactor 3.

Steam methane reformer 2 includes a reactor section 32 and a convective section 34. As illustrated, burners 36 and 38 fire into reactor section 32 to heat reactor tubes 40 and 41. Although only two burners are shown and two reactor tubes are shown in the illustration, as would be known to those skilled in the art, there would be multiple burners in a steam methane reformer as well as several hundred of such reactor tubes. The fuel for the burners 36 and 38 is provided by a natural gas stream 44 and a tail gas stream 92. Reactor tubes 40 and 41 are fed by first reactant stream 26 after having been heated. In this regard, a flue gas stream 46 produced by the combustion occurring within reactor section 32 is then used to heat first reactant stream 26 in a heat exchanger 48 that is located within convective section 34. Steam methane reforming reactions and water-gas shift reactions occurring within reactor tubes 40 and 41 produce a first synthesis gas stream 42.

A steam generation system is integrated into the steam methane reformer 2 and consists of elements within the following description. Further heat exchangers 52 and 50 are provided within the convective section 34 to raise and superheat steam. A steam stream 54 from a steam drum 56 is superheated within heat exchanger 50 to produce a superheated steam stream 58. Superheated steam stream 58 is divided into a first superheated steam stream 24 and an export steam stream 60 and is further divided into second superheated steam stream 28. Although not illustrated, the steam generated by a process gas boiler 62 is superheated within convective section 34 and then used as part of the makeup of first and second superheated steam streams 24 and 28 or optionally export steam stream 60. The steam is raised within steam drum 56 by passing boiler water stream 148 into heat exchanger 52 to produce steam containing stream 68 that is fed back to steam drum 56. Steam drum 56 is fed with water heated in boiler feed water heater 72 a demineralized water heater 70 through indirect heat exchange with a shifted stream 86 to be discussed hereinafter. Although not illustrated, but as would be known to those skilled in the art, the resulting heated water discharged from boiler feed water heater 72 would have been de-aerated after leaving demineralized water heater 70 and prior pumping to raise the water pressure which is subsequently fed to boiler feed water heater 72. Additionally, the shifted stream 86 is cooled within a cooler 74 which as known in the art is a combination of air cooler and cooling water. After water is condensed out, the shifted stream 86 is fed to pressure swing adsorption unit 88 to separate hydrogen and to produce a hydrogen product stream 90 and the hydrogen recycle stream 94. It is to be noted that shifted stream 86 additionally passes through preheater 76 in order to preheat natural gas stream 10 and hydrogen recycle stream 94 as needed for the hydrotreater 14.

As indicated above, second reactant stream 30 is reacted in catalytic reactor 3. Catalytic reactor 3 can be of the type that employs a burner 75 to fire into catalyst bed 76. Second reactant stream 30 along with an oxygen stream 77, that would in practice have a purity of at least 95 percent by volume and preferably 99 percent by volume, is fed into burner 75. As will be discussed, a heat exchanger 80 heats the second reactant stream 30 to a sufficient high temperature that when second reactant stream 30 combines with the oxygen provided by oxygen stream 77 combustion of the hydrocarbon content is spontaneous. However, in certain reactors, a pilot flame is additionally employed to ensure combustion. Burner 75 is designed to generate a stable flame in which the oxygen and the feed are thoroughly mixed and reacted. The burner may be cooled using plant cooling water or boiler feed water. The oxygen may be obtained from liquid storage tanks, a pipeline, or an on-site air separation unit. Optionally, the oxygen stream 77 could be mixed with a portion of the superheated steam prior to being introduced into catalytic reactor 3. Although not illustrated, the oxygen stream 77 could be preheated prior to being introduced into catalytic reactor 3, before and/or after any optional steam addition.

Downstream of the burner, the mixture is passed over the catalyst bed 76. The oxygen driven exothermic reactions provide the energy necessary to drive steam reforming reactions over the catalyst. No external heating is provided. Any supported catalyst active for steam reforming may be used. For instance, Group VIII metals (i.e. Fe, Co, Ni, Ru, Rh, Pd, Os, Ir, Pt) may be loaded onto ceramic or metal-based supports, such as pellets, shaped particles, honeycomb monoliths, foam monoliths, or corrugated foil monoliths. A bed of Ni-loaded ceramic shaped particles could be used. The catalyst bed 76 could include a metal, corrugated foil monolith as a support for one or more noble metal catalysts (e.g. Pt, Pd, Rh, Ru). Preferably, the catalyst bed is designed to operate at a gas hourly space velocity of above about 50,000 hours⁻¹ and more preferably above 100,000 hours⁻¹.

Consequently, the partial oxidation reactions resulting from the combustion of part of the hydrocarbon content of second reactant stream 30 in the burner 75 coupled with further steam methane reforming and water-gas shift reactions over the catalyst in catalyst bed 76 produce hydrogen and carbon monoxide that are discharged from catalytic reactor 3 as a second synthesis gas stream 78 that passes through heat exchanger 80 to preheat the second reactant stream 30. As would be apparent to those skilled in the art, the preheating of second reactant stream 30 also helps to conserve the oxygen required in catalytic reactor 3. The second synthesis gas stream 78 is combined with the first synthesis gas stream 42 to produce a combined stream 82. Combined stream 82 is passed through the product gas boiler 62 and after having been cooled into water-gas shift reactor 84 where steam and carbon monoxide react to produce hydrogen and a shifted stream 86 having a greater hydrogen content than combined stream 82. Shifted stream 86 is then cooled by passage through pre-heater 76, boiler feed water heater 72, demineralized water heater 70 and then through cooler 74. The resulting cooled shifted stream 86 is then introduced into a pressure swing adsorption unit 88 to separate hydrogen from the shifted stream 86 by means of adsorbent beds in a known manner and produce a hydrogen product stream 90 and a tail gas stream 92. Part of the product stream 92, as a hydrogen stream 94 may be combined with natural gas stream 10 as needed for hydrotreating purposes.

The catalytic reactor 3 is controlled by controlling steam to feedstock and oxygen to feedstock molar ratios to maintain the temperature of second synthesis gas stream 78 at a temperature of no greater than about 870° C., although temperatures within a range of between about 700° C. and about 870° C. are possible. In addition, the methane slip and hydrogen to carbon monoxide ratio within second synthesis gas stream 78 are maintained similar to that existing in first synthesis gas stream 42 or greater and at least 2.0 dry mol percent and 4.0 on a molar basis, respectively. This can be done with control valves, not illustrated, that would be set to control the flow of oxygen 77 and the second hydrocarbon containing feed stream 22 and second superheated steam stream 28 based upon an analysis of second synthesis gas stream 78 by a gas analyzer.

As an Example, the molar ratio of the steam to hydrocarbon reactants within second feed stream 30 of about 3.4 and the molar ratio of oxygen to hydrocarbon reactants within the catalytic reactor 3 of about 0.46 have been calculated to result in the second synthesis gas stream 78 having a temperature of about 816° C., a methane slip of about 6.0 dry mol percent and a hydrogen to carbon monoxide molar ratio of about 5.4. After passage through heat exchanger 80, second synthesis gas stream 78 would cool to 604° C. An optional boiler feed water, spray-quench trim cooler can be utilized to further reduce the process gas boiler exit temperature. It has been calculated that less than about 1 US gallons per minute of boiler feed water would be used to reduce normal exit temperatures of product gas boiler 62 from about 366° C. to about 360° C.

Steam methane reformer 2 is operated in a conventional manner with a steam to carbon molar ratio of about 3.2 and an with first synthesis gas stream 42 having a temperature of about 866° C., a 3.2 dry mol percent methane slip and a hydrogen to carbon monoxide molar ratio of about 5.1. The burners 36 and 38 provide about 136.3 MMBTU/hr low heating value of fired duty to steam methane reformer 2 to process about 890 mscfh of the first hydrocarbon containing feed gas stream 20, which undergoes a 28.3 psi pressure drop between the heat exchanger 48 and the product gas boiler 62. The steam methane reforming occurring within steam methane reformer 2 accounts for 13.41 MMSCFD of the hydrogen production produced by the separation occurring within pressure swing adsorption unit 88. With the use of a catalytic reactor 3, operated as described above, hydrogen production has been calculated to increase to 16.8 MMSCFD, a 25.3 percent increase. The only reformer characteristic that changes slightly is reformer fired duty. This increases by 4.5 percent to 142.2 MMBTU/hr low heating value due to an increase of flow of tail gas stream 92 as a fraction of the total fuel fed to burners 38 and 36. In other words, the flow rate of the remaining part of the fuel supplied to burners 36 and 38 by way of natural gas stream 44 can be reduced.

For proper, stable operation, the burners employed in the catalytic reactor 3 may require a temperature of second reactant stream 30 to be preheated within heat exchanger 80 to a temperature in excess of about 510° C. However, during startup of the catalytic reactor 3 temperatures may be as low as 316° C. In such cases, an ignition device or procedure of some type is required. This could include an electronic igniter or specially-designed startup burner. Preferably, however, the following procedure is utilized. Though not shown, the existing plant already recycles some product hydrogen as hydrogen recycle stream 94 to the natural gas feed stream 10 so that any olefins or organic sulfurs are hydrogenated within the hydrotreater 14. During normal operation, hydrogen recycle stream 94 would amount to about 2.5 percent of the flow of the natural gas feed stream 10. During startup of the catalytic reactor 3, the hydrogen recycle stream 94 will be increased such that the hydrogen content of the second feed gas stream 22 rises to between about 5 and about 20 mol %. While the hydrogen content of the natural gas feed stream 10 could be increased, it is more efficient and preferable to route a portion of the hydrogen recycle stream 94 directly to the second feed gas stream 22 to the catalytic reactor 3 upstream of heat exchanger 80. Increasing the hydrogen content of the second feed gas stream 22 to between 5 and 20 mol % will advantageously assist startup in two ways. First, for certain burners, the wider flammability limits may lower the ignition temperature to a level below between about 316° C. and about 371° C., thereby allowing the burner to light off and operate stably without further feed preheat. Second, if the burner has not ignited, the increase in hydrogen content will promote ignition over the catalyst bed. As the net exothermic reactions proceed, heat generated in the catalyst bed employed in the catalytic reactor 3 will be transferred to the second feed gas stream 22 by way of heat exchanger 80. Once the feed reaches an adequate temperature, for instance, 510° C., burner ignition and stable operation will occur. Either way, following burner ignition and stable operation, the flow rate of the hydrogen recycle stream 94 can be returned to normal levels.

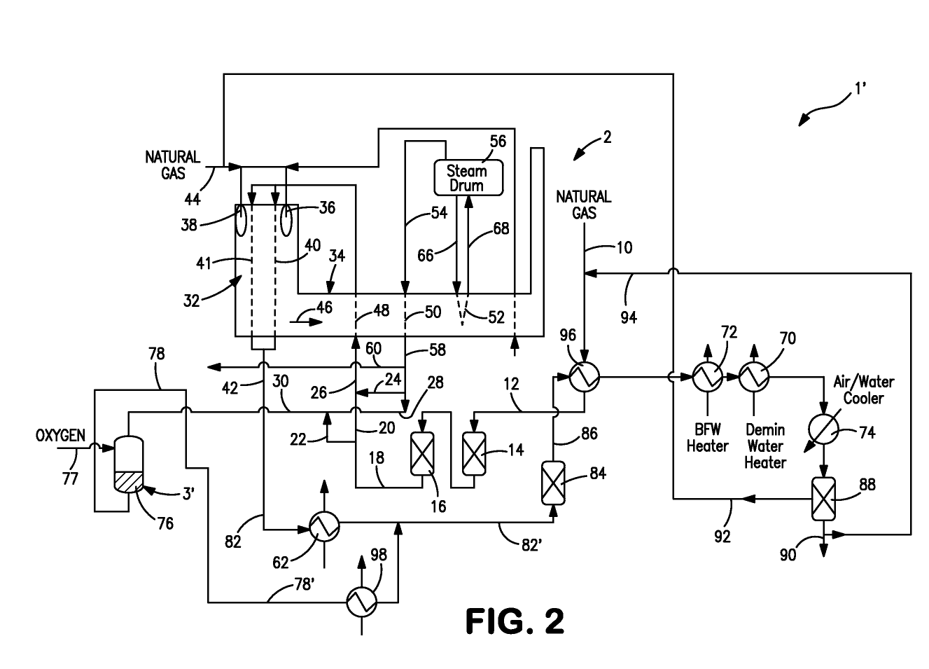

As illustrated in FIG. 2 a hydrogen plant 1′ is shown that employs a catalytic reactor 3′ as a retrofit that is designed to function without a burner and at lower temperatures. It is to be noted that hydrogen plant 1′ is otherwise the same as hydrogen plant 1 and as such, the same reference numbers have been used for elements thereof that have been described above in connection with hydrogen plant 1. The use of catalytic reactor 3′ will consume more oxygen and reactant and as such the flow rate of second reactant stream 30 will increase. In this regard, in the practice of such embodiment, the heat exchanger 80 is eliminated and the inlet temperature of the second reactant stream 30 would be about 338° C. The oxygen stream can be introduced into the catalytic reactor 3′ by means of a known mixer assembly, not illustrated, designed to thoroughly and rapidly mix the oxygen with the second reactant feed stream 30 and deliver the mixture to a catalyst bed 96 employed in such a reactor. Preferably, no flame exists and the ignition is delayed until the mixture reaches the catalyst bed. Upon contact with the catalyst bed 96, the exothermic, oxygen-driven reactions occur in parallel with and provide the necessary energy for the steam reforming reactions. No external heating is provided. Any of the catalyst bed configurations described previously may be used. For such embodiment, a layered catalyst bed may be particularly advantageous. First, an optional layer of inert, ceramic pellets or shaped particles may be used to impart additional mixing to the reactants. This layer would contain no active catalyst. Second, a ceramic or metal-based honeycomb, foam or corrugated foil monolith loaded with a noble metal catalyst (e.g. Pt, Pd, Rh, Ru) would be used. The low surface area but thermally stable monolith would promote rapid completion of the oxidation reactions while withstanding the highest temperatures of the catalyst bed. Third, a layer of high surface area, catalyst-loaded, ceramic pellets or shaped particles would be used. The high activity and improved radial mixing of this layer would uniformly bring the slower, endothermic reforming reactions to a close approach to equilibrium.

Steam to feedstock and oxygen to feedstock molar ratios is controlled to maintain the second synthesis gas stream 78′ at a temperature of between about 704° C. and about 871° C. In addition, the methane slip and hydrogen to carbon monoxide ratio would be maintained similar to or greater than that of the steam methane reformer 2 and at least 2.0 dry mol percent and 4.0 on a molar basis, respectively. By way of example, steam to feed and oxygen to feed molar ratios of about 3.4 and about 0.60 result in the second synthesis gas stream having a temperature of about 816° C. Methane slip and the ratio between hydrogen and carbon monoxide are about 5.0 dry mol percent and about 5.3, respectively.

Since heat exchanger 80 has been eliminated, the second synthesis gas stream is cooled to about 357° C. in an auxiliary boiler 98. Although not illustrated, auxiliary boiler 98 is fed by the boiler feed water heater 72 and returns produced steam to the steam drum 56. Auxiliary boiler 98 could be provided with a cold side internal bypass to control the exit temperatures, similar to most process gas boilers. Although not illustrated, the FIG. 1 embodiment could use an auxiliary boiler with combination of the hydrogen and carbon monoxide containing streams after the product gas boiler 62. This of course would not be desirable in that it would increase the cost of the retrofit. As illustrated, the cooled second synthesis gas stream 78′ is combined with the first synthesis gas stream 42 to produce a combined stream 82′ that is further processed in the same manner as combined stream 82 in the embodiment shown in FIG. 1.

Assuming a like operation of steam methane reformer 2 in the FIG. 2 embodiment, the only reformer characteristic that changes slightly is reformer fired duty. This increases by 5.1 percent to 143.3 MMBTU/hr low heating value due to an increase of tail gas stream 92 as a fraction of the total fuel. Also, as described above, if necessary, additional hydrogen recycle can be used to aid catalyst ignition during startup.

Compared to the FIG. 1 embodiment, the embodiment illustrated in FIG. 2 has certain advantages and disadvantages. Advantageously, more export steam is produced (e.g. 45.7 kpph vs. 40.7 kpph for the FIG. 1 embodiment) with less overloading of the existing product gas boiler 62. Advantageously, a boiler feed water spray quench is avoided and the syngas effluent isolation valve can operate at a lower temperature (e.g. 371° C. vs. 621° C.). Disadvantageously, additional tie-ins to the existing plant are required, mainly with the existing steam system. And most disadvantageously, almost 30 percent more oxygen is consumed. It has been calculated that the lower feed preheat temperatures increase oxygen usage from 37.4 to 48.4 tons per day.

While the invention has been described with reference to preferred embodiments, as will occur to those skilled in the art, numerous changes, additions and omission can be made without departing from the spirit and scope of the present invention as set forth in the appended claims.

We claim:

1. A method of producing a hydrogen containing product comprising:
reacting a first hydrocarbon containing feed gas stream with steam in a steam methane reformer of an existing hydrogen plant to produce a first synthesis gas stream;
increasing production of the hydrogen within the existing hydrogen plant by retrofitting the existing hydrogen plant with a catalytic reactor and reacting a second hydrocarbon containing feed gas stream with steam and oxygen within the catalytic reactor to produce a second synthesis gas stream and such that said second synthesis gas stream has a methane slip of at least about 2.0 dry mol percent, a hydrogen to carbon monoxide ratio of at least about 4.0 on a molar basis and a temperature of no greater than about 870° C.;
combining said second synthesis gas with the first synthesis gas stream to produce a combined stream;
cooling the combined stream or separately cooling the first synthesis gas stream and the second synthesis gas stream such that the combined stream is at a temperature suitable for introduction into a water-gas shift reactor of the existing hydrogen plant;
subjecting the combined stream to at least one stage of a water-gas shift reaction conducted within the water-gas shift reactor to form a shifted stream having more of the hydrogen than the combined stream; and
utilizing synthesis gas in the shifted stream in a downstream unit operation to produce the hydrogen containing product;
whereby, an amount of the synthesis gas provided to the shifted stream available for the downstream unit operation is increased by virtue of combination of the second synthesis gas stream with the first synthesis gas stream.

2. The method of claim 1, wherein:
the downstream unit operation is a hydrogen pressure swing adsorption unit; the shifted stream is cooled and the hydrogen is separated from the shifted stream within the hydrogen pressure swing adsorption unit to produce a hydrogen stream containing the hydrogen as the hydrogen containing product and a tail gas stream; and
the tail gas stream is utilized as part of a fuel fed to burners firing into a furnace section of the steam methane reformer at a tail gas flow rate of the tail gas stream that is greater than before the retrofit of the catalytic reactor to decrease consumption of a remaining part of the fuel.

3. The method of claim 2, wherein:
a feed gas stream containing hydrocarbons and sulfur species is treated by passing the feed gas stream through a hydrotreater of the existing hydrogen plant to hydrogenate the sulfur species to hydrogen sulfide and then through an adsorbent bed of the existing hydrogen plant to adsorb the hydrogen sulfide, thereby to form a treated feed gas stream;
the treated feed gas stream is divided into the first hydrocarbon containing feed gas stream and the second hydrocarbon containing feed gas stream; and
the flow rate of the feed gas stream after the retrofit of the catalytic reactor is increased.

4. The method of claim 3, wherein:
the catalytic reactor has a burner fed with a reactant stream and the oxygen and firing into a catalyst bed;
the second hydrocarbon containing feed stream is combined with the further part of the steam to form the reactant stream that is heated through indirect heat transfer with the second synthesis gas stream, thereby to partly cool the second synthesis gas stream; and
the combined stream is cooled prior to being subjected to the at least one stage of the water-gas shift reaction within a product gas boiler of the existing hydrogen plant.

5. The method of claim 3, wherein:
the catalytic reactor has a catalyst configured to promote reactions between the second hydrocarbon containing gas stream, the oxygen and the steam; and
the first synthesis gas stream is cooled in a product gas boiler of the existing hydrogen plant and the second synthesis gas stream is separately cooled within an auxiliary boiler.

6. The method of claim 3 or claim 4 or claim 5, wherein the feed gas stream and the remaining part of the fuel fed to the burners is natural gas.

7. An apparatus for producing a hydrogen containing product comprising:
an existing hydrogen plant including a steam methane reformer, a steam generation system associated with the steam methane reformer to generate steam and at least one water-gas shift reactor in flow communication with the product gas boiler to produce a shifted stream;
the steam methane reformer configured to react part of the steam with a first hydrocarbon containing feed gas stream to produce a first synthesis gas stream;
a catalytic reactor retrofitted to the existing hydrogen plant, the catalytic reactor configured to react a second hydrocarbon containing feed gas stream with oxygen and a further part of the steam to produce a second synthesis gas stream and such that said second synthesis gas stream has a methane slip of at least about 2.0 dry mol percent, a hydrogen to carbon monoxide ratio of at least about 4.0 on a molar basis and a temperature of no greater than about 870° C.;
the at least one water-gas shift reactor in flow communication with both the catalytic reactor and the steam methane reformer such that the second synthesis gas stream combines with the first synthesis gas stream to produce a combined stream fed into the at least one water-gas shift reactor;
at least one boiler positioned between the catalytic reactor and the water-gas shift reactor such that the combined stream is at a temperature suitable for entry into the at least one water-gas shift reactor; and
a production apparatus in flow communication with the at least one water-gas shift reactor utilizing synthesis gas in the shifted stream to produce the hydrogen containing product;
whereby, an amount of the synthesis gas provided to the shifted stream available for the production apparatus is increased by virtue of combination of the second synthesis gas stream with the first synthesis gas stream such that production of the hydrogen containing product is increased.

8. The apparatus of claim 7 wherein:
the production apparatus is a hydrogen pressure swing adsorption unit configured to separate the hydrogen from the shifted stream to produce a hydrogen product stream as the hydrogen containing product and a tail gas stream;
the hydrogen pressure swing adsorption unit connected to burners firing into a furnace section of the steam methane reformer such that the tail gas stream is fed as part of a fuel to burners; and
the existing hydrogen plant with the catalytic reactor configured to operate such that the pressure swing adsorption unit produces the hydrogen product stream and the tail gas stream at increased production rates over the existing hydrogen plant due to the combination of the second synthesis gas stream with the first synthesis gas stream and consumption of a remaining part of the fuel fed to the burners decreases due to increased production of the tail gas stream.

9. The apparatus of claim 8, wherein:
the existing hydrogen plant has a hydrotreater positioned upstream of the steam methane reformer and the catalytic reactor to treat a feed gas stream by hydrogenating sulfur species present within the natural gas stream to hydrogen sulfide and an adsorbent bed is connected to the hydrotreater to adsorb the hydrogen sulfide and thereby form a treated feed gas stream; and
the steam methane reformer and the catalytic reactor are in flow communication with the adsorbent bed such that the treated feed gas stream is divided into the first hydrocarbon containing feed gas stream and the second hydrocarbon containing feed gas stream.

10. The apparatus of claim 9, wherein:
the catalytic reactor has a burner fed with the second hydrocarbon containing feed gas stream and the oxygen and firing into a catalyst bed;
a heat exchanger is positioned between the catalytic reactor and the adsorption bed and in flow communication with the steam generation system such that the second hydrocarbon containing feed gas stream combines with the further part of the steam to produce a reactant stream fed to the catalytic reactor that is preheated through indirect heat transfer with the second synthesis gas stream, thereby to cool the second synthesis gas stream; and
the at least one boiler is a product gas boiler of the existing hydrogen plant in flow communication with both the steam methane reformer and the catalytic reactor.

11. The apparatus of claim 9, wherein:
the catalytic reactor has a catalyst configured to promote reactions between the second hydrocarbon containing gas stream, the oxygen and the steam; and
the at least one boiler comprises a product gas boiler of the existing hydrogen plant and an auxiliary boiler, the product gas boiler is in flow communication with the steam methane reformer such that first synthesis gas stream cools within the product gas boiler and the auxiliary boiler is in flow communication with the catalytic reactor such that the second synthesis gas stream cools within the auxiliary boiler.

12. The hydrogen plant of claim 9 or claim 10 or claim 11 or claim 12, wherein the feed gas stream and the remaining part of the fuel fed to the burners is natural gas.
